(19) United States
(12) Patent Application Publication
(10) Pub. No.: US 2014/0159866 A1
(43) Pub. Date: Jun. 12, 2014

(54) USER CUSTOMIZED REMOTE KEYLESS ENTRY SYSTEM AND METHOD

(71) Applicant: HYUNDAI MOTOR COMPANY, Seoul (KR)

(72) Inventor: Jong Won Hwang, Hwaseong (KR)

(73) Assignee: HYUNDAI MOTOR COMPANY, Seoul (KR)

(21) Appl. No.: 13/858,373

(22) Filed: Apr. 8, 2013

(30) Foreign Application Priority Data
Dec. 7, 2012 (KR) 10-2012-0141898

(51) Int. Cl. G08C 17/02

(52) U.S. Cl. CPC G08C 17/02
USPC 340/5.64

(57) ABSTRACT

A user customized remote keyless entry system and method is capable of operating various devices disposed within a vehicle at an operation distance set by a user. The system includes a controller that is configured to compare position information of a vehicle control apparatus with position information transmitted from a remote control apparatus when the remote control apparatus transmits a control command for a specific device disposed within the vehicle and current position information to the vehicle control apparatus. In addition, the controller is configured to execute an operation of a corresponding device when a spaced distance between the remote control apparatus and the vehicle control apparatus satisfies a preset condition.

### CROSS-REFERENCE TO RELATED APPLICATION

This application is based on and claims priority from Korean Patent Application No. 10-2012-0141898, filed on Dec. 7, 2012 in the Korean Intellectual Property Office, the disclosure of which is incorporated herein in its entirety by reference.

### BACKGROUND OF THE INVENTION

1. Field of the Invention

The present invention relates to a user customized remote keyless entry system and a method, and more particularly, to a technology that allows a user to arbitrarily set remote operation distances of various devices in a vehicle, such as a door, a trunk, a window, a sun roof, and the like.

2. Description of the Prior Art

Generally, a vehicle has a circuit that locks or unlocks a door by operating an actuator according to a mechanical key operation through a key insertion.

Recently, a remote keyless entry (RKE) system allowing a door to be automatically unlocked when the driver enters a predetermined distance from the vehicle has been provided. The remote keyless entry (RKE) system is configured to unlock the door by allowing an actuator sensing an RKE remote controller to drive a motor when the driver approaches the vehicle holding the RKE remote controller and automatically locks the door when the driver turns off the ignition, exits the vehicle, and then moves by a predetermined distance or more from the vehicle.

In addition, the remote keyless entry system may control the opening and closing of a trunk, a window, a door, and a sun roof of the vehicle. In the remote keyless entry system according to the prior art as described above, a distance for operating various devices in the vehicle is fixed, thus the system is not customizable.

Particularly, in the remote keyless entry system according to the prior art, an operation distance is not uniform, thus, it may be difficult to predict whether the remote keyless entry system will be operated at a specific distance and in a specific direction, operations such as a window closing operation, a sun roof closing operation, and the like, need to be performed at a short distance in view of safety, but may not be differentiated from other operations, and the trunk may be opened when a remote controller button is erroneously pressed at a long distance.

### SUMMARY

Accordingly, the present invention provides a user customized remote keyless entry system capable of operating various devices disposed within a vehicle at an operation distance set by a user by allowing a vehicle control apparatus to compare position information of the vehicle with position information transmitted from a remote control apparatus when the remote control apparatus transmits a control command for a specific device in the vehicle and current position information to the vehicle control apparatus and control an operation of a corresponding device when a spaced distance between the remote control apparatus and the vehicle control apparatus satisfies a preset condition, in a remote keyless entry system including the remote control apparatus and the vehicle control apparatus, and a method thereof.

According aspect of the present invention, a remote control apparatus may include: a plurality of units executed by a controller having a processor and a memory. The plurality of units may include a command inputting unit that may be configured to receive a control command to control operations of various devices disposed within a vehicle, based on a user input; a position information acquiring unit configured to acquire current position information; and a communicating unit configured to transmit the control command and the position information to the vehicle control apparatus acquired by the position information acquiring unit, when the command inputting unit receives the control command.

In another aspect of the present invention, a vehicle control apparatus may include: a plurality of units executed by a controller having a processor and a memory. The plurality of units may include an operation distance setting unit configured to receive operation distances of various devices disposed within a vehicle, set by a user; a communicating unit configured to communicate with a remote control apparatus to receive a control command and position information; and a driving unit configured to drive various devices disposed within the vehicle. Additionally, the controller may be configured to compare the position information of the remote control apparatus and position information of the vehicle control apparatus in response to receiving the control command and the position information and executing an operation of a corresponding device according to the control command when a spaced distance between the remote control apparatus and the vehicle control apparatus is within an operation distance of a corresponding device.

In still another aspect of the present invention, a remote control method may include: receiving, by a controller, a control command of various devices disposed within a vehicle, based on a user input; acquiring, by the controller, current position information; and transmitting, by the controller, the control command and the position information to a vehicle control apparatus.

In still another aspect of the present invention, a vehicle control method may include: receiving, by a controller, operation distances of various devices disposed within a vehicle, based on a user setting; receiving, by the controller, a control command and position information transmitted from a remote control apparatus; comparing, by the controller, the received position information and position information of a vehicle control apparatus and executing control command when a spaced distance between the remote control apparatus and the vehicle control apparatus is within an operation distance of a corresponding device; and operating, the corresponding device.

### BRIEF DESCRIPTION OF THE DRAWINGS

The above and other objects, features and advantages of the present invention will be more apparent from the following detailed description taken in conjunction with the accompanying drawings, in which:

FIG. 1 is an exemplary configuration diagram of a user customized remote keyless entry system according to an exemplary embodiment of the present invention;

FIG. 2 is an exemplary configuration diagram of a remote control apparatus according to the exemplary embodiment of the present invention;

FIG. 3 is an exemplary configuration diagram of a vehicle control apparatus according to the exemplary embodiment of the present invention;

FIG. 4 is an exemplary illustrative diagram for operation distances of various devices within a vehicle according to the exemplary embodiment of the present invention;

FIG. 5 is an exemplary a flowchart of a remote control method according to the exemplary embodiment of the present invention; and

FIG. 6 is an exemplary flowchart of a vehicle control method according to the exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, exemplary embodiments of the present invention will be described in detail with reference to the accompanying drawings.

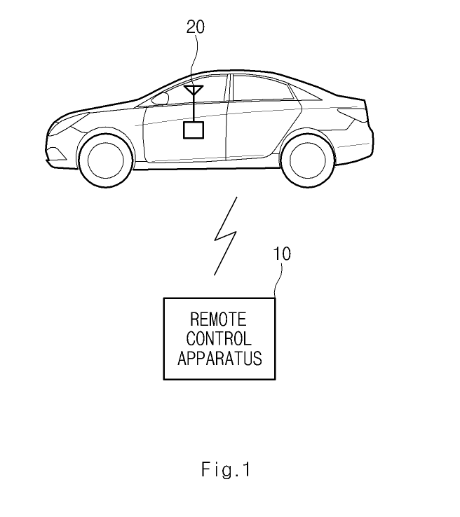

FIG. 1 is an exemplary configuration diagram of a user customized remote keyless entry system according to an exemplary embodiment of the present invention. As shown in FIG. 1, the user customized remote keyless entry system according to the exemplary embodiment of the present invention may include a remote control apparatus 10 and a vehicle control apparatus 20.

First, the remote control apparatus 10, may be a substantially small apparatus held by a user and may be capable of wirelessly transmitting commands to control various devices disposed within a vehicle, for example, commands to lock or unlock a door and open or close a trunk, a window, a sun roof, and the like, to the vehicle control apparatus 20. Particularly, the remote control apparatus 10 may include a plurality of units executed by a controller having a processor and a memory. The plurality of units may include a position information acquiring unit (e.g., a global positioning system (GPS) receiver) configured to acquire current position information in real time and transmit the current position information with the control command to the vehicle control apparatus 20.

Moreover, the vehicle control apparatus, may be an apparatus mounted within the vehicle to control operations of various devices disposed within the vehicle, and may be configured to control an operation of a corresponding device based on the control command remotely received from the remote control apparatus 10. Particularly, the vehicle control apparatus 20, executed by a controller, may be configured to compare the position information received from the remote control apparatus 10 and position information of the vehicle control apparatus 20 to calculate a spaced distance and execute a corresponding control command when the calculated spaced distance is a threshold value or lower, corresponding to the control command. For example, when a threshold value for an opening operation of the sun roof is 30 m, the vehicle control apparatus 20 may be configured to open the sun roof when the actually calculated spaced distance is within 30 m and may be configured to not open the sun roof when the actually calculated spaced distance exceeds 30 m.

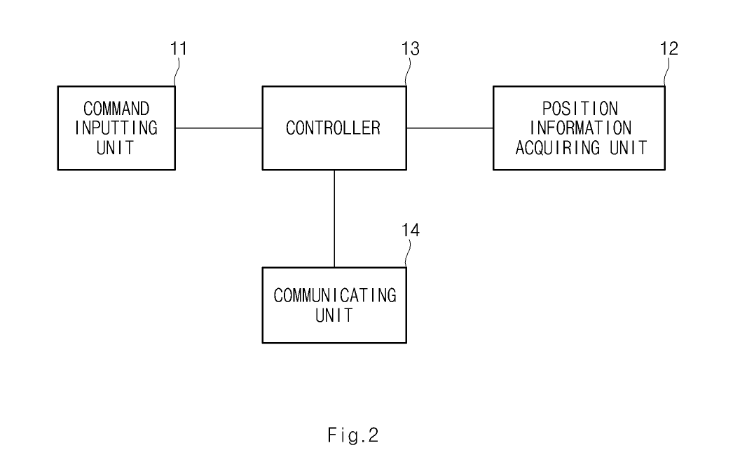

FIG. 2 is an exemplary configuration diagram of a remote control apparatus according to the exemplary embodiment of the present invention. As shown in FIG. 2, the remote control apparatus according to the exemplary embodiment of the present invention may include a plurality of units executed by a controller 13 having a processor and a memory. The plurality of units may include a command inputting unit 11, a position information acquiring unit 12, and a communicating unit 14.

Each of the above mentioned units will be described below. First, the command inputting unit 11 may be implemented in a button scheme or a touch scheme and may be configured to receive a control command to execute operations of various devices disposed within the vehicle, based on a user input. In particular, the control command may include a command to lock or unlock each door of the vehicle, a command to open or close the trunk, a command to open or close the window, a command to open or close the sun roof, or the like. Furthermore, the door and the window may be divided into a driver seat door and window, a passenger seat door and window, a left backseat door and window, and a right backseat door and window, and the command inputting unit 11 may be configured to receive a control command for each of the above-mentioned doors and windows. The command inputting unit 11 may further include an audio recognizer configured to receive a control command from the user as audio.

The position information acquiring unit 12 may be configured to acquire the current position information through a global positioning system (GPS) receiver, or the like. The position information acquiring unit 12 may further be configured to acquire the current position information through a wireless communication network.

The communicating unit 14 may be configured to transmit the received control command and the position information acquired by the position information acquiring unit 12 to the vehicle control apparatus 20 when the control command is received from the user through the command inputting unit 11.

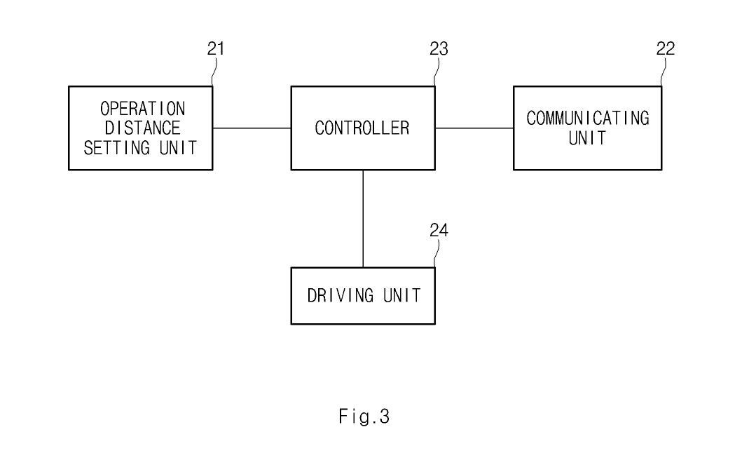

FIG. 3 is an exemplary configuration diagram of a vehicle control apparatus according to the exemplary embodiment of the present invention.

As shown in FIG. 3, the vehicle control apparatus according to the exemplary embodiment of the present invention may include a plurality of units executed by a controller 23 having a processor and a memory. The plurality of units may include: an operation distance setting unit 21, a communicating unit 22, and a driving unit 24. Each of the above-mentioned units will be described below.

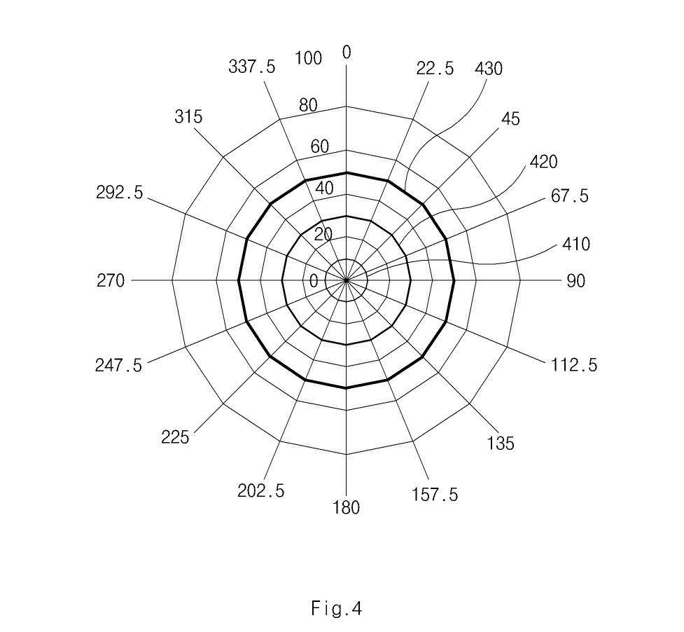

First, the operation distance setting unit 21 may be configured to receive operation distances of various devices disposed within the vehicle, based on a user setting. For example, as shown in FIG. 4, an operation distance of window locking, trunk opening, and sun roof closing may be 10 m (410), an operation distance of door unlocking, sun roof opening, and window opening may be 30 m (420), and an operation distance of door locking may be 50 m (430), but the present invention is not limited thereto. In particular, the operation distances of the remote keyless entry system may be substantially the same (e.g., the operation distances are represented in a circular shape) in all directions (i.e., 16 directions, 0 degree may indicate the front of the vehicle and 180 degrees may indicate the rear of the vehicle) of the vehicle. The operation distance setting unit 21 may be operated when a key inserted into a key holder of the vehicle or a valid smart key is sensed, thereby allowing only a valid user to set operation distances of each device.

Moreover, the communicating unit 22 may be configured to communicate with the remote control apparatus 10 to receive the control command and the position information. In other words, the communicating unit 22 may be configured to receive the control command selected by the user and the position information of the remote control apparatus 10 from the remote control apparatus 10. In particular, the communicating unit 22 may be configured to perform communication through near field communication such as Bluetooth, WiFi, Infrared, or the like, or perform communication through mobile communication (e.g., 3G, 4G long term evolution (LTE), 4G, or the like).

Furthermore, the controller 23 may be configured to compare the position information of the remote control apparatus 10 and the position information of the vehicle control apparatus 20 in response to receiving the control command for the specific device disposed within the vehicle and the position information of the remote control apparatus 10 and control an operation of a corresponding device when a spaced distance between the remote control apparatus 10 and the vehicle control apparatus 20 is within an operation distance of the corresponding device.

In other words, the controller 23 may be configured to compare the position information of the remote control apparatus 10 and the position information of the vehicle control apparatus 20 in response to receiving the control command for the specific device in the vehicle and the position information of the remote control apparatus 10. In addition, the driving unit 24 may be configured to be operated based on the control command when the spaced distance between the remote control apparatus 10 and the vehicle control apparatus 20 is within the operation distance of the corresponding device set through the operation distance setting unit 21. Next, the driving unit 24 may be configured to operate various devices disposed within the vehicle.

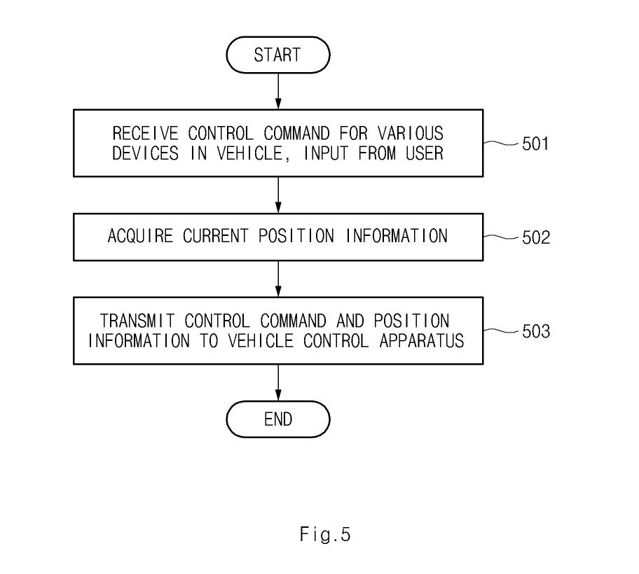

FIG. 5 is an exemplary flowchart of a remote control method according to the exemplary embodiment of the present invention.

The remote control process may include: receiving, by the controller, the control command of various devices disposed within the vehicle, based on a user input (501); acquiring, by the controller, the current position information (502); transmitting, by the controller, the received control command and the acquired position information acquired to the vehicle control apparatus (503).

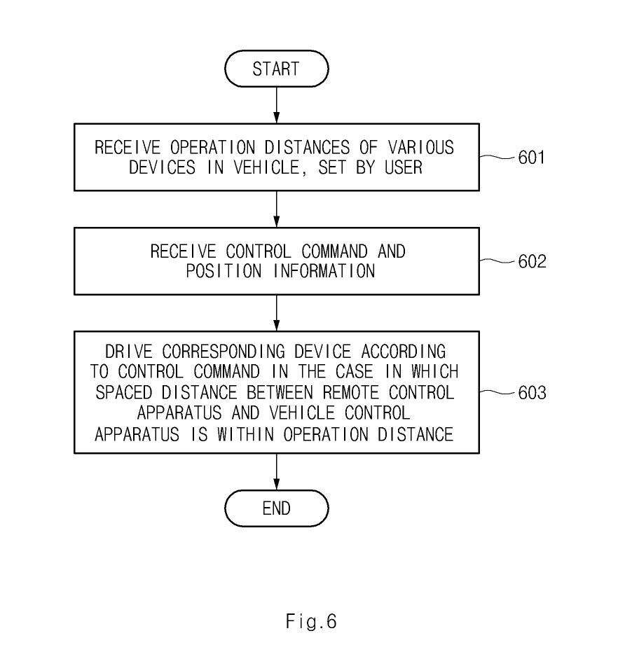

FIG. 6 is an exemplary flowchart of a vehicle control method according to the exemplary embodiment of the present invention.

First, the vehicle control process may include: receiving, by the controller, the operation distances of various devices disposed within the vehicle, based on a user setting (601); receiving, by the controller, the control command and the position information transmitted from the remote control apparatus (602); comparing, by the controller, the received position information and the position information of the vehicle control apparatus 20; and executing, by the controller, the control command when the spaced distance between the remote control apparatus 10 and the vehicle control apparatus 20 is within an operation distance of the corresponding device (603).

As set forth above, according to the exemplary embodiments of the present invention, in the remote keyless entry system including the remote control apparatus and the vehicle control apparatus, the vehicle control apparatus may be configured to compare position information of the vehicle control apparatus with position information transmitted from the remote control apparatus when the remote control apparatus transmits the control command for the specific device disposed within the vehicle and the current position information to the vehicle control apparatus and may be configured to control the operation of the corresponding device in when the spaced distance between the remote control apparatus and the vehicle control apparatus satisfies a preset condition, thereby operating various devices disposed within a vehicle at an operation distance set by a user.

In addition, according to the exemplary embodiments of the present invention, in the remote keyless entry system including the remote control apparatus and the vehicle control apparatus, the vehicle control apparatus may be configured to compare position information of the vehicle control apparatus with position information transmitted from the remote control apparatus when the remote control apparatus transmits the control command for the specific device disposed within the vehicle and the current position information to the vehicle control apparatus and may be configured control the operation of the corresponding device when the spaced distance between the remote control apparatus and the vehicle control apparatus satisfies a preset condition, thereby allowing the operation distances of the remote keyless entry system to be substantially the same in all directions (for example, 16 directions) of the vehicle.

What is claimed is:

1. A remote control apparatus comprising:
a controller configured to:
receive a control command to control operations of various devices disposed within a vehicle, based on a user input;
acquire current position information;
transmit the received control command and the acquired position information acquired to a vehicle control apparatus in response to receive the control command; and
transmitting the control command and the position information to the vehicle control apparatus.

2. The remote control apparatus according to claim 1, wherein the control command includes a command to lock or unlock a door, a command to open or close a trunk, a command to open or close a window, or a command to open or close a sun roof.

3. A vehicle control apparatus comprising:
a controlled configured to:
receive operation distances of various devices disposed within a vehicle, based on a user setting;
communicate with a remote control apparatus to receive a control command and position information;
compare the position information of the remote control apparatus and position information of the vehicle control apparatus, in response to receiving the control command and the position information;
execute an operation of a corresponding device based on the control command when a spaced distance between the remote control apparatus and the vehicle control apparatus is within an operation distance of a corresponding device; and
operate various devices disposed within the vehicle.

4. The remote control apparatus according to claim 3, wherein the control command includes a command to lock or unlock a door, a command to open or close a trunk, a command to open or close a window, or a command to open or close a sun roof.

5. A remote control method comprising:
receiving, by a controller, a control command for various devices disposed within a vehicle, based on a user input;
acquiring, by the controller, current position information; and
transmitting, by the controller, the received control command and the acquired position information to a vehicle control apparatus.

6. The remote control method according to claim 5, wherein the control command includes a command to lock or unlock a door, a command to open or close a trunk, a command to open or close a window, or a command to open or close a sun roof.

7. A vehicle control method comprising:
receiving, by a controller, operation distances of various devices disposed within a vehicle, based on a user setting;
receiving, by the controller, a control command and position information transmitted from a remote control apparatus;
comparing, by the controller, the received position information and position information of a vehicle control apparatus;
executing, by the controller, the control command when a spaced distance between the remote control apparatus and the vehicle control apparatus is within an operation distance of a corresponding device; and
operating, by the controller, the corresponding device.

8. The vehicle control method according to claim 7, wherein the control command includes a command to lock or unlock a door, a command to open or close a trunk, a command to open or close a window, or a command to open or close a sun roof.

9. A non-transitory computer readable medium containing program instructions executed by a processor or controller, the computer readable medium comprising:
program instructions that receive a control command for various devices disposed within a vehicle, based on a user input;
program instructions that acquire current position information; and
program instructions that transmit the received control command and the acquired position information to a vehicle control apparatus.

10. The remote control method according to claim 9, wherein the control command includes a command to lock or unlock a door, a command to open or close a trunk, a command to open or close a window, or a command to open or close a sun roof.

11. A non-transitory computer readable medium containing program instructions executed by a processor or controller, the computer readable medium comprising:
program instructions that receive operation distances of various devices disposed within a vehicle, based on a user setting;
program instructions that receive a control command and position information transmitted from a remote control apparatus;
program instructions that compare the received position information and position information of a vehicle control apparatus;
program instructions that execute the control command when a spaced distance between the remote control apparatus and the vehicle control apparatus is within an operation distance of a corresponding device; and
program instructions that operate the corresponding device.

12. The remote control method according to claim 11, wherein the control command includes a command to lock or unlock a door, a command to open or close a trunk, a command to open or close a window, or a command to open or close a sun roof.
